(19) United States
(12) Patent Application Publication
(10) Pub. No.: US 2008/0007409 A1
(43) Pub. Date: Jan. 10, 2008

(54) Making and securing identification tags

(76) Inventors: Kristel L. Ferry, Methuen, MA (US); Howard A. Kingsford, Amherst, NH (US); Mark A. Clarner, Concord, NH (US); David P. Kraus JR., Amherst, NH (US); Christopher M. Gallant, Nottingham, NH (US); Kenneth M. Leigh, Nashua, NH (US); William Grenier, Manchester, NH (US)

Correspondence Address: FISH & RICHARDSON PC, P.O. BOX 1022, MINNEAPOLIS, MN, 55440-1022, US

(21) Appl. No.: 11/821,228

(22) Filed: Jun. 21, 2007

Related U.S. Application Data
(60) Provisional application No. 60/805,454, filed on Jun. 21, 2006.

(51) Int. Cl. G06K 19/06

(52) U.S. Cl. 340/572.1; 264/238

(57) ABSTRACT

Various method of making RFID tags, RF-responsive antennae and other circuitry in flexible sheet form with touch fastener elements extending from one side of the sheet, for securing the tags. Some methods include continuous roll forming methods and/or the filling of molded channels with conductive compositions.

### CROSS REFERENCE TO RELATED APPLICATIONS

This application claims the benefit of U.S. Provisional Patent Application No. 60/805,454, filed Jun. 21, 2006, which is incorporated herein by reference in its entirety.

### TECHNICAL FIELD

This invention relates to making and securing circuits, such as identification tags, with touch fasteners.

### BACKGROUND

Much effort has recently been expended to develop improved circuitry and systems for wireless tracking of objects, such as by Radio Frequency IDentification, or RFID. The cost of RFID tags has been reduced to the point that it is now commercially feasible to incorporate them even into disposable packaging.

All such tags feature antennae, typically in the form of a conductive trace arranged to be responsive to a weak, externally applied field oscillating at a given frequency. Typically they also contain a few, fairly inexpensive electronic components coupled to the antenna.

Improvements in the design and manufacturing of such identification tags are sought, as well as improvements in the manufacturing of electrical circuitry generally, and in the means of attaching such tags and/or other circuitry to a supporting surface.

### SUMMARY

According to one aspect, an identification tag includes a flexible sheet-form base having a broad surface formed of resin, electrically conductive material, and an array of fastener elements extending from the broad surface of the base. The conductive material is carried by the base, forming a conductive path and defining at least a portion of an antenna responsive to externally applied electromagnetic radiation oscillating at a predetermined frequency. The fastener elements are arranged and constructed to engage predetermined frequency. The fastener elements are arranged and constructed to engage mating fastener elements to selectively secure the tag.

In some embodiments, the fastener elements are shaped to releasably engage exposed loop fibers associated with a supporting surface to which the tag is to be secured. In some cases, the fastener elements are raised projections of the resin of the broad surface of the base, or at least each have stems molded of resin contiguous with the resin forming the broad surface of the base. The array of fastener elements is substantially coextensive with the broad surface of the base in many instances.

The identification tag preferably has an entire thickness, measured from distal ends of the fastener elements to an exposed broad surface of the base opposite the fastener elements, of less than about 0.1 inch (2.5 millimeters), more preferably less than about 0.05 inch (1.25 millimeters).

In some embodiments the fastener elements each have distal heads overhanging the base to form loop-engaging crooks.

In some examples the antenna is encased within the base. For example, the antenna may be disposed between a first layer of resin forming the broad surface and insulating one side of the antenna, and a second layer of resin insulating another side of the antenna. The first and second layers of resin may consist of a single seamless extent of a single resin material, or may be of differing material properties. In some cases the first and second layers are permanently welded to one another in a manner to encompass the antenna.

For many applications the fastener elements each have a height, measured from the broad surface of the base, of less than about 0.05 inch, and the array of fastener elements has a density of at least about 20 fastener elements per square centimeter (in some cases, at least 50, or even at least 75, fastener elements per square centimeter).

In many instances the tag also includes at least one discrete electrical component carried by the base and coupled to the antenna. In some cases the electrical component includes a circuit mounted in a sealed housing fully or at least partially embedded in the base. In some configurations the electrical component includes a circuit in electrical communication with the antenna and at least partially electrically isolated by resin of the base.

In some embodiments, an identification tag includes a wrist strap. In some cases, the tag has a head defining an aperture adjacent one end of the tag, and the fastener elements include a row of projections that cooperate with a feature of the head to prevent withdrawal of the tag from the aperture with an opposite end of the tag inserted through the aperture. In some cases, the fastener elements are configured to releasably engage other fastener elements of the tag when the tag is wrapped about an object to engage itself. For example, the other fastener elements can include loops. In some cases, the base defines a discrete frangible region spaced from longitudinal ends of the tag and spanning at least one electrically conductive member of the tag, such that breaking the base at the frangible region renders the tag inoperable.

In some embodiments, the identification tag defines a receptacle sized to receive an electronic component, the tag comprising electrically conductive connection surfaces positioned to establish electrical connectivity between the antenna and the received component. In some cases, identification tags are combined with an electronic component disposed within the receptacle, the electronic component comprising a microprocessor and containing a unique component identification code. In some cases, the receptacle is bounded by at least one wall having component retention features that extend into the receptacle and prevent removal of a received electronic component. In some cases, the receptacle includes an electronic component removal slot arranged to permit sliding a received electronic component laterally out of the receptacle.

Some other aspects of the invention feature methods of continuously forming a series of identification tags.

One method involves introducing a thermoplastic resin into a gap formed adjacent a peripheral surface of a rotating mold roll, the mold roll defining an array of cavities therein, the resin being introduced under pressure and temperature conditions selected to cause the resin to at least partially fill the cavities to form fastener element stems integrally with and extending from one broad surface of a strip of said resin, while introducing a preformed strip into the gap. The preformed strip includes a support substrate carrying a series of discrete electrical traces configured to form at least portions of antennae responsive to externally applied electromagnetic radiation oscillating at a predetermined frequency. The preformed strip is introduced so as to cause the resin to bond with the preformed strip and form a laminate material having a flexible resin base carrying both an exposed array of fastener element stems and a series of antennae.

In some applications the method also includes severing the laminate material into discrete identification tags, each tag containing an antenna and a multiplicity of exposed fastener elements.

In some cases the electrical traces each include a continuous, coiled, flexible trace of conductive material forming a conductive path of length greater than a lateral extent of the antenna.

In some instances the cavities of the mold roll are shaped to mold distal heads on the fastener element stems, the distal heads being shaped to overhang the broad surface of the strip of resin so as to be releasably engageable with exposed loop fibers. In some other instances each of the stems defines a tip portion, the method further including deforming the tip portion of a plurality of the stems to form engaging heads overhanging the broad side of the strip of resin and shaped to be engageable with exposed loop fibers.

In some cases the gap is a nip defined between the rotating mold roll and a counter-rotating pressure roll.

In some embodiments the support substrate includes a film carrying the conductive material on its surface. The resin is introduced to the gap directly adjacent the rotating mold roll, and the film is introduced to the gap under pressure and temperature conditions that cause the film to become permanently bonded to the resin to envelop and electrically isolate the antennae.

Another method features molding a continuous, flexible base of an electrically insulating thermoplastic resin, while forming a series of channels in a surface of the base; at least partially filling the formed channels with a flowable, electrically conductive composition; stabilizing the flowable composition in the channels to form a pattern of stable, electrically conductive traces within the channels; and providing a series of discrete electronic circuits carried by the flexible base. Each circuit is electrically connected to a corresponding one of the traces to form a trace-circuit pairing, and each trace-circuit pairing is responsive to externally applied electromagnetic radiation oscillating at a predetermined frequency.

In some cases, at least partially filling the formed channels includes using printing techniques to dispense conductive ink into the channels.

In some cases, at least partially filling the formed channels includes dispensing the flowable composition onto the surface of the base, and then substantially removing the flowable composition from non-channel regions of the surface.

In some examples, removing the flowable composition includes wiping the surface.

In some embodiments the flowable composition is in powder form prior to stabilization. In some cases the flowable composition comprises a liquid carrier solution containing metal ions, or a suspension of conductive particles.

The composition may be stabilized in the channels by evaporating a solvent from the composition, or by radiating the composition in the channels with radiation selected from a group consisting of heat, ultraviolet radiation, and microwave radiation, or by subjecting the composition to reducing conditions, or by releasing reducing agents from capsules contained within the flowable composition.

In some examples molding the base includes feeding the thermoplastic resin in a moldable form into a gap adjacent a mold roll. The gap may be defined between the mold roll and a counter-rotating roll, for example. The method also includes, in some cases, forming a field of loop-engageable fastener elements extending from the base by introducing the resin into the gap such that the resin fills a field of fixed cavities defined in the mold roll to form a field of molded stems; solidifying the molded stems; stripping the stems from the mold roll; and then forming loop-engageable heads on the molded stems.

For some applications the method includes, prior to filling the channels, surface-treating the channels to promote adhesion of the flowable composition.

In some cases the method also includes providing a field of loop-engageable fastener elements on the base exposed to releasably secure the base to a loop-bearing support, such as by integrally molding the fastener elements with the base such that the fastener elements extend outwards from a surface of the base. The fastener elements may be provided by attaching preformed fastener element tape to the base.

In some cases the method includes attaching an electrically insulating cover over the conductive traces, with the cover attached to the base. Attaching the insulative layer may include passing the sheet-form base through a gap adjacent a mold roll in the presence of moldable resin to encapsulate the conductive traces, or spraying an insulating composition onto the base, such that the insulating composition encapsulates the conductive traces.

Another aspect of the invention features a method of forming a flexible identification tag with integral touch fastener elements.

One method includes introducing an elongated flexible circuit strip including a substrate and a series of longitudinally spaced apart tag circuits carried by the substrate to a gap adjacent a peripheral surface of a mold roll having an array of stem forming cavities extending inwardly from the peripheral surface, while simultaneously introducing a thermoplastic resin into the gap directly adjacent the peripheral surface under temperature and pressure conditions causing the thermoplastic resin to at least partially fill the stem forming cavities and to permanently bond to the substrate. The permanently joined thermoplastic resin and substrate is then stripped the from the mold roll to expose the fastener element stems. Various embodiments can provide particularly efficient methods of making RFID tags as well as other circuits, and providing such circuits in many cases with integral touch fastener elements. Flexible circuits with integral touch fasteners may be readily releasable and repositionable, and identification tags employing such fastening means, reusable.

In some aspects, a n electronically readable wrist strap includes: an elongated and flexible strip of resin having opposite longitudinal ends and securable about a wrist of a wearer; electrically conductive material carried by the strip and forming a conductive path that defines at least a portion of an antenna responsive to externally applied electromagnetic radiation oscillating at a predetermined frequency; and electronic circuitry in electrical communication with the antenna and containing an electronically readable identification code. The strip defines a discrete frangible region spaced from the longitudinal ends and spanning at least one electrically conductive member of the strap, such that breaking the strip at the frangible region to remove the strap from the wrist renders the strap unreadable.

In some embodiments, electronically readable wrist straps further include an array of fastener elements extending from the broad surface of the base, the fastener elements arranged and constructed to engage mating fastener elements to selectively secure the tag. In some cases, the fastener elements comprise raised projections of the resin of the broad surface of the base.

In some embodiments, the antenna is disposed between a first layer of resin forming the broad surface and insulating one side of the antenna, and a second layer of resin insulating another side of the antenna. In some cases, the first and second layers of resin consist of a single, seamless extent of a single resin material. In some cases, the first and second layers are of differing material properties.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a fastenable RFID tag.

FIG. 2A is a partial cross-section view of the tag, according to a first configuration.

FIG. 2B is a side view of the tag of 2A in use.

FIG. 3 is a partial cross-section view of the tag, according to a second configuration.

FIG. 4 is a partial cross-section view of the tag, according to a third configuration.

FIG. 5 is a perspective view of another fastenable RFID tag.

FIG. 6 is a perspective view of a rolled, continuous strip of RFID tags.

FIG. 7 is a schematic illustration of a first method of making a continuous length of fastenable RFID tag material.

FIG. 8 is a schematic illustration of a second method of making a continuous length of fastenable RFID tag material.

FIG. 8A is an enlarged, sectional view of area 8A in FIG. 8.

FIG. 8B is a longitudinal cross-sectional view of the preform strip product molded in the nip of the method of FIG. 8.

FIG. 8C is a longitudinal cross-sectional view of the final product of the method of FIG. 8, releasably engaged with a loop material.

FIG. 8D is a cross-sectional view, taken along line 8D-8D in FIG. 8.

FIG. 9 is a schematic illustration of a third method of making a continuous length, of fastenable RFID tag material.

FIG. 10 is a schematic illustration of a fourth method of making a continuous length of fastenable RFID tag material, showing the placement of discrete electronic components.

FIG. 11 is a schematic illustration of a fifth method of making a continuous length of fastenable RFID tag material.

FIG. 11A is a schematic illustration of a sixth method of making a continuous length of fastenable RFID tag material.

FIG. 11B is an enlarged partial perspective view of the printing roller of FIG. 11A.

FIG. 12 is a schematic illustration of a seventh method of making a continuous length of fastenable RFID tag material, such as the material of FIG. 5.

FIG. 13 is a longitudinal, partial cross-sectional view of a surface region of the mold roll of the method of FIG. 12, illustrating mold roll construction and surface features.

FIG. 14 is a perspective view of an RFID tag with a releasably securable shielding flap, in an open, readable position.

FIG. 14A shows the tag of FIG. 14 in a folded, unreadable position.

FIGS. 15, 15A, and 15B are, respectively, a perspective view, a cross-sectional view, and an enlarged side view of portions of a fastener product including a fastenable strap with an RFID tag,

FIG. 16 is a perspective view of a fastener product including fastenable strap.

FIGS. 17A, 17B, and 17C are, respectively, a perspective view, a cross-sectional view, and an enlarged cross-sectional view of a portion of a strap with a modular RFID assembly.

FIG. 18 is a perspective view of a fastener product including a fastenable strap.

Like reference symbols in the various drawings indicate like elements.

### DETAILED DESCRIPTION

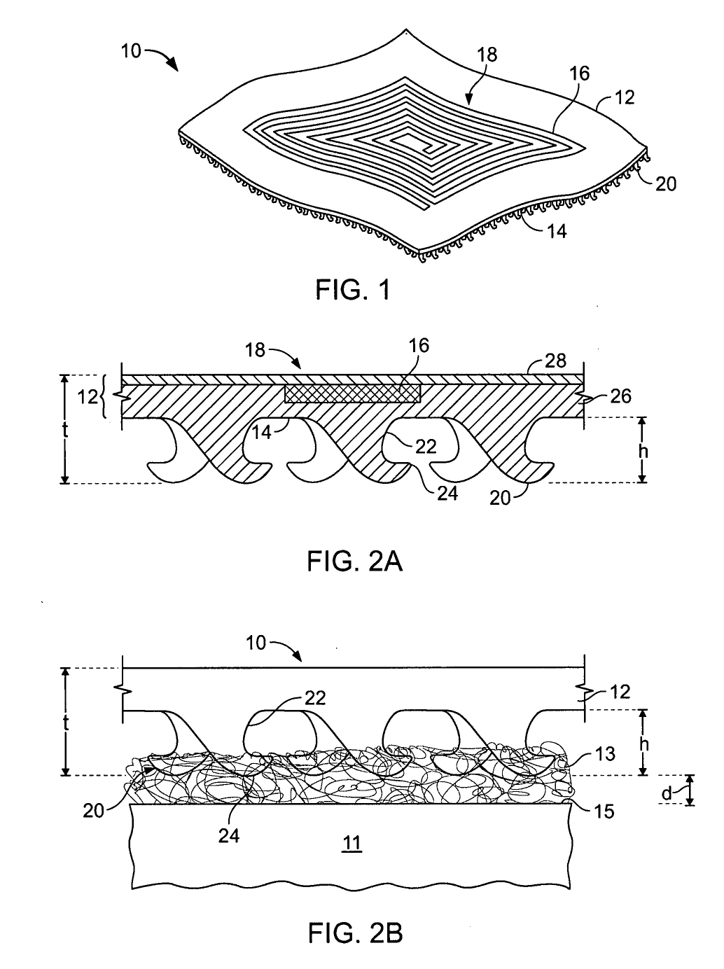

Referring to FIG. 1, an identification tag 10 has a flexible sheet-form base 12 having a broad surface 14 formed of resin, and electrically conductive material 16 carried by base 12. Material 16 forms a conductive path and defines an antenna 18 responsive to externally applied electromagnetic radiation oscillating at a predetermined frequency. How to configure such a path to form a responsive antenna is known in the RFID art. In this illustration the path forms a straight-sided spiral, with an outer end and an inner end, and having an overall effective conductive length far greater than the lateral extent of the pattern of conductive material on the tag. The spiral path forms an inductor that is coupled with a capacitor, provided either as a discrete mounted component or formed between spaced apart conductive layers, one of which is configured as an extension of the conductive path. The inductor and capacitor together define a resonant frequency of the antenna, as is known in the art. A microchip (not shown in this figure) is coupled to the antenna and stores a unique digital tag identifier. This example features a passive RFID device, but active devices with energy storage, such as batteries, are also envisioned. The RFID tag is configured to function as a transponder, according to ISO 15693 up-link communication protocol.

An array of fastener elements 20 extends from the broad surface 14 of base 12, the fastener elements arranged and constructed to engage mating fastener elements (such as loop elements, not shown) associated with a supporting surface, such as a fabric garment, to selectively secure the tag to the supporting surface. As shown, the array of fastener elements 20 is substantially coextensive with the broad surface 14 of base 12, and has a density of at least about 150 fastener elements per square centimeter.

Referring next to FIGS. 2A and 2B, tag 10 has an overall thickness ‘t’ of about 1.0 millimeter, with the fastener elements 20 extending to a height ‘h’ of about 0.4 millimeter from the near surface of base 12. In the example shown, fastener elements 20 are shaped to releasably engage exposed loop fibers associated with a supporting surface, and are formed as raised projections of the resin of the broad surface of the base, by a roll-forming method described below. A suitable projection shape is the CFM29 hook shape, of about 0.015 inch (0.38 mm) in height, available in various products sold by Velcro USA of Manchester, N.H. Alternative projection shapes, such as mushrooms, palm trees, flat-topped hooks, or other loop engageable shapes are also suitable. The illustrated fastener elements 20 are hook-shaped, each having a molded stem 22 of resin contiguous with the base resin, and a distal crook 24 overhanging the base to engage loop fibers. Adjacent rows of hooks face in opposite directions.

In the example of FIG. 2A, antenna 18 is encased within base 12, between the layer 26 of resin forming the broad surface 14 from which the fastener elements 20 extend, and insulating one side of antenna 18, and a second layer 28 of resin insulating the opposite side of the antenna. In this case, layer 28 is a film to which conductive material 16 is bonded, and has different material properties than the resin of layer 26 and fastener elements 20. Film 28 is permanently welded to layer 26 to encompass antenna 18 and any other discrete electrical components (not shown) carried by film 26.

In use, referring to FIG. 2B, tag 10 can be attached to a discrete object 11 to be identified by engagement between the fastener elements 20 and loop fibers 13 which are affixed to a exterior surface 15 of the object 11. The spacing between the base 12 of tag 10 and the exterior surface 15 of object 11 is at least the height h of the fastener elements 20. As illustrated, in some cases, engagement between the fastener elements 20 and loop fibers 13 positions the tag 10 an additional distance d apart from the object 11. For example, the hook/loop interface results in the conductive portions of the tag being spaced at least 0.02 inch, and in some cases at least 0.04 inch, away from the nearest surface of the object. In some cases, the space between the base 12 of tag 10 and the exterior surface 15 of object 11 provides an air cushion between base 12 (including conductive material 16 (see FIG. 2A) and/or associated microchips) and object 11 and improves the electrical and heat transfer characteristics of the overall system.

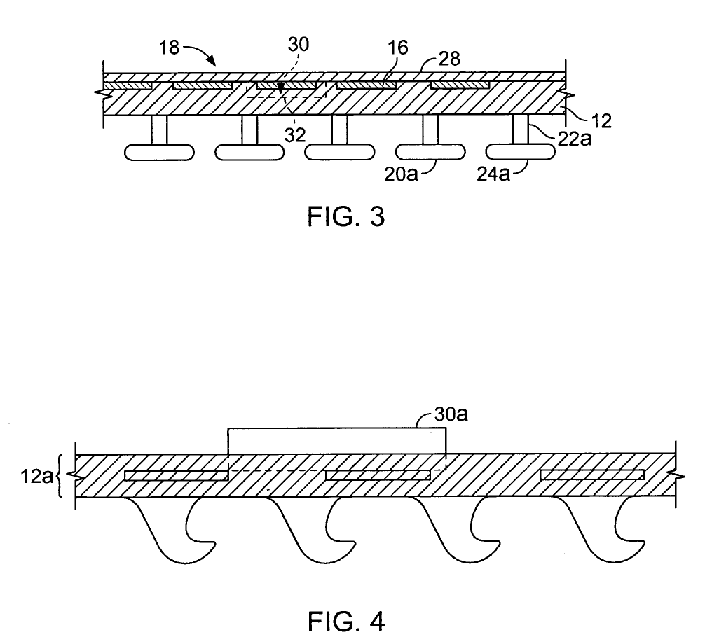

In the example of FIG. 3, fastener elements 20a are shown as mushroom-type fastener elements, with molded stems 22a of resin and overhanging heads 24a formed by permanently deforming molded, distal ends of the stems to overhang base 12. Shown in dashed outline is a discrete electrical component 30 carried by the base and coupled to the antenna 18. In this example, component 30 is a set of components forming a circuit sealed within a chip housing 32, and the configuration of such housed circuits for use with RFID antennae is known in the art. The chip housing 32 containing the circuit is of rigid plastic, and in this example is fully disposed within base 12. However, such circuits may also be configured without a discrete housing 30, or with an at least partially open housing, with resin of base 12 electrically isolating and sealing the circuit with respect to the environment.

For example, in the configuration of FIG. 4, circuit housing 30a is only partially embedded in base 12a, and electrical connections to the antenna trace at the underside of housing 30a are electrically isolated by resin of base 12a, which in this case is a single contiguous extent of a single resin material that forms both surfaces of base 12a.

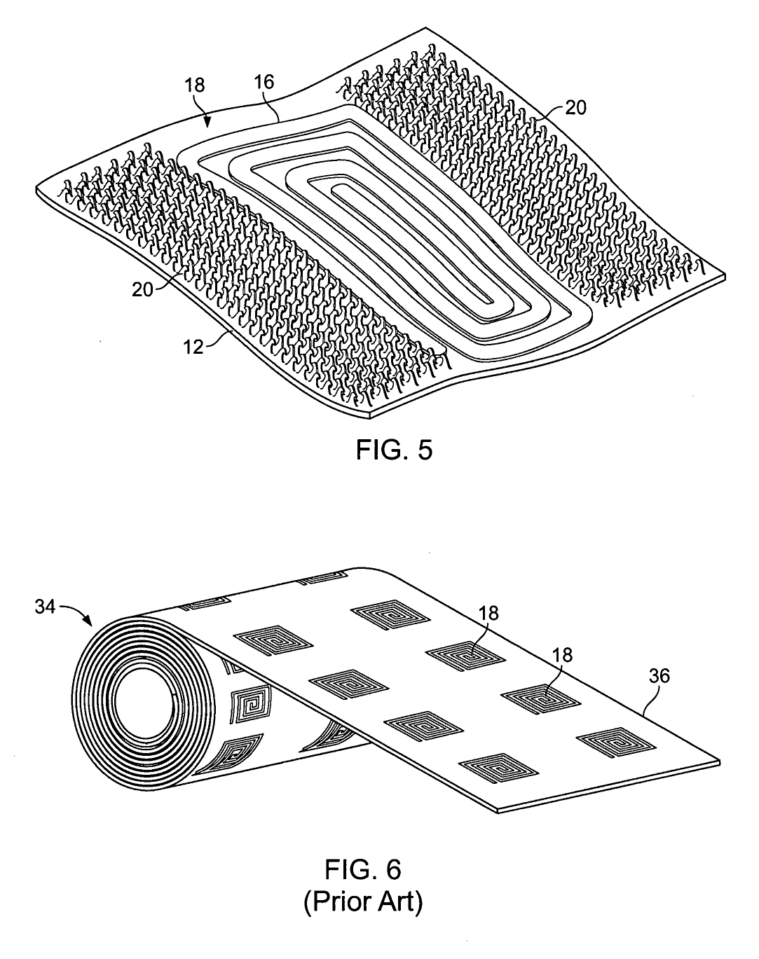

FIG. 5 illustrates yet another example, in which arrays of fastener elements 20 extend along either side of a single face of base 12, with conductive material 16 disposed on the same face of base 12 to form an antenna between the fastener element arrays. Fastening the fastener elements to a fibrous material shields the antenna from environmental damage but does not interfere with its reception.

Many methods are envisioned for forming the above-described identification tags. One such method begins with a roll 34 of carrier material 36, such as film, to which a series of RFID antennae 18 are adhered, as shown in FIG. 6. Such rolled RFID tag strips are commercially available, such as TAG-IT™ foil inlay RFID tags from Texas Instruments. In this example, carrier 36 carries two parallel columns of RFID antennae.

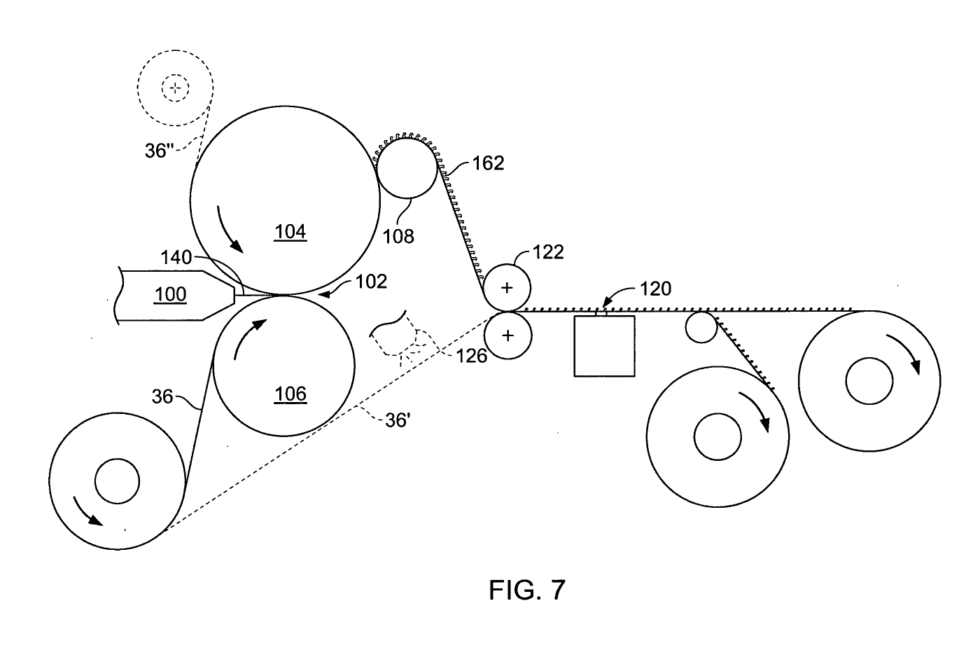

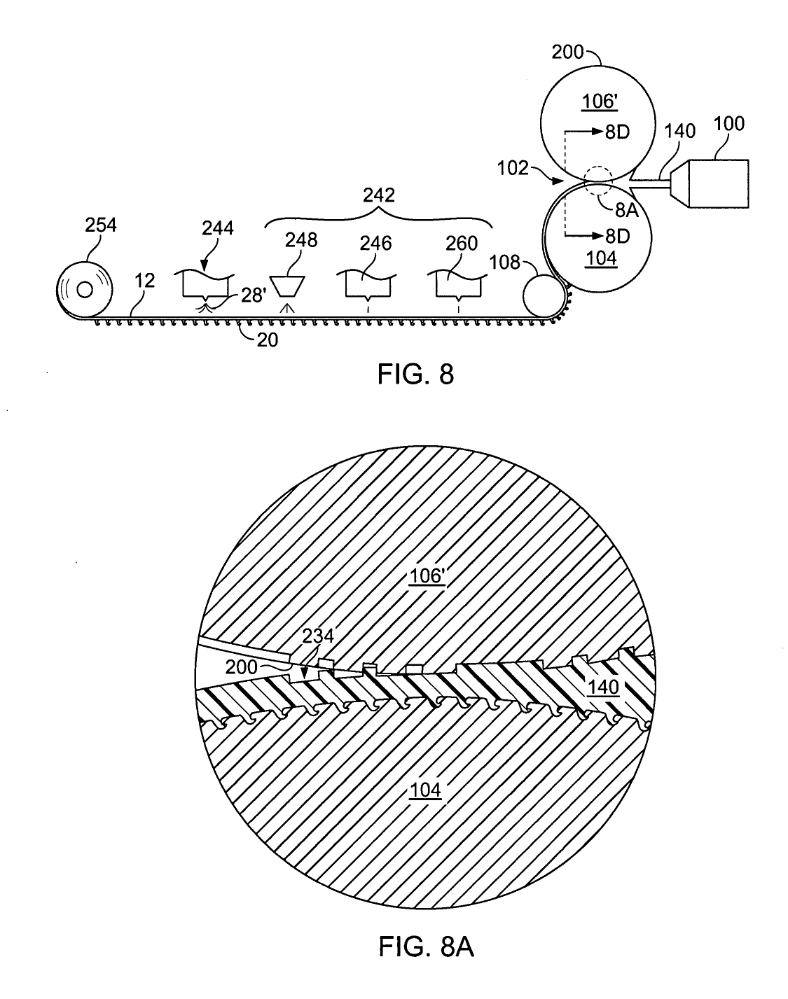

FIG. 7 illustrates how such a material is incorporated into a roll-forming process to form identification tags with fastener elements. The illustrated methods build upon the continuous extrusion/roll-forming method for molding fastener elements on an integral, sheet-form base described by Fischer in U.S. Pat. No. 4,794,028, and the nip lamination process described by Kennedy et al. in U.S. Pat. No. 5,260,015. The reader is referred to both of these patents, each of which is hereby incorporated by reference, for further information. The relative position and size of the rolls and other components is not to scale. An extrusion head 100 supplies a continuous sheet of molten resin 140 to a nip 102 between a rotating mold roll 104 and a counter-rotating pressure roll 106. Mold roll 104 contains an array of miniature, fastener element-shaped mold cavities extending inward from its periphery for molding the fastener protrusions, e.g. 20 (FIG. 2). Pressure in nip 102 forces resin into the fastener element cavities and forms at least the fastener element side of the base.

The formed product is cooled on the mold roll until the solidified fastener elements (e.g., hooks) are stripped from their fixed cavities by a stripper roll 108. Along with the molten resin, the continuous antennae carrier strip 36 is fed into nip 102, where it is bonded with resin 140 and becomes a permanent part of the base of the resulting product, pressure and temperature conditions in the nip causing the antennae carrier strip to become permanently bonded to the resin to envelop and electrically isolate the antennae. Thus, the product 162 that is stripped from the mold roll 104 includes both fastener elements 20 and RFID antennae 18 as illustrated, for example, in FIG. 2 described above. A protruding splitting channel ring (not shown; or multiple rings if more than two columns of antennae are provided) at the center of the mold roll (or spaced according to the width of the individual antennae columns) produces a splitting channel in the product, along which the resulting tape is split by a blade 120 (either stationary or rotating) into two (or more) separate runs of fastener identification tags, which are separately spooled. Each finished spool of tag material can then be processed to form individual identification tags, such as by severing the laminate material between individual antennae, such that each tag contains an antenna and a multiplicity of exposed fastener elements.

FIG. 7 indicates variations of the above-described method. For instance, rather than introduce the RFID antennae strip 36 through nip 102 and thereby join it to the substrate as the substrate is molded, the antennae strip may be joined to the resin layer of the base after the base has been formed, such as is indicated by the run 36′ of antennae strip shown in dashed outline. In this case, front face idler 122 is heated and has a contoured surface to bond the antennae strip and the resin base in desired areas while not damaging the molded hooks. As an alternative to heat lamination, a preformed strip of RFID tags can be adhesive laminated to a preformed hook fastener tape, as illustrated by adhesive sprayer 126, with the base of the hook tape carrying the RFID antenna in each laminated product.

Other forming methods are also envisioned. For example, molten resin can be injected directly into the mold roll cavities under pressure applied by a stationary molding shoe, with the antennae strip laminated to an obverse side of the resin base while the fastener elements are solidifying in their cavities. Direct mold roll injection is more fully described, for example, in U.S. Pat. No. 5,441,687, issued Aug. 15, 1999, to Murasaki et. al, also incorporated herein by reference.

In another example illustrated in FIG. 7, a thin film strip 36″ carrying the columns of antennae is introduced against the surface of mold roll 104, with pressure in nip 102 forcing the molten resin through the film to fill the cavities in the mold roll. This results in a tag product having the carrier film disposed on its fastening face, with fastener elements extending individually up through the film in areas not occupied by the conductive material. In such cases the conductive material traces should be configured so as to not be disrupted by resin pressure. Other details of molding resin through a film can be found in pending U.S. patent application Ser. No. 11/280,035, filed Nov. 15, 2005 and incorporated herein by reference.

In any of the methods described herein, the mold roll cavities may be shaped to form stems only, without an undercut portion for forming an engaging head of a fastener element. In such cases the product (e.g., 162) stripped from the mold roll has only integrally molded stems protruding from its upper surface. Subsequent to the stripping operation, the product is passed between a heated roller and an anvil roller (such as at rolls 122 in FIG. 7) to produce a final product. The heated roller contacts and deforms the tip portion of each stem to form a loop-engageable head portion that overhangs the base, such as in the product shown in FIG. 3. Alternatively, the stems can be heated with a non-contact heat source and deformed with a chilled roller. Examples of these techniques are more fully illustrated in U.S. Pat. No. 5,077,870 issued Jan. 7, 1992 to Melbye et al. and U.S. Ser. No. 09/231,124, filed Jan. 15, 1999, respectively. The reader is referred to both of these references, incorporated herein by reference, for further information.

In yet another suitable technique, a thermoplastic base is extruded having continuous rails of hook fastener-shaped profile. The rails, but not the base, are subsequently slit laterally at intervals along the length of the extrusion to form separate portions of the fastener-shaped rail, each portion separated from an adjacent portion by a slit. The base is then permanently stretched longitudinally to create space between adjacent portions of the fastener-shaped rails. The resulting fastener tape has rows of spaced individual hook fastener elements. Such a technique is more fully described for example, in U.S. Pat. No. 4,894,060, issued Jan. 16, 1990 and also incorporated herein by reference. To such extruded, slit and stretched product a strip of RFID antennae may be laminated as discussed above, and then severed into individual identification tags.

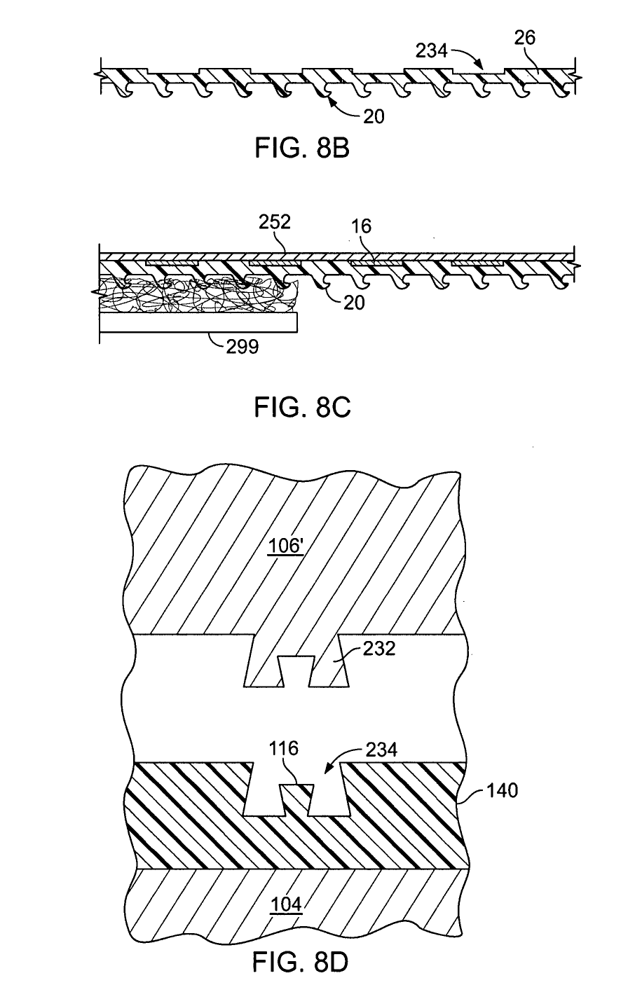

Another method of forming identification tags features forming the conductive antenna directly on the tag base, rather than using preformed strips of RFID tags. Referring to FIGS. 8-8D, an extruder 100 feeds molten resin 140 into a nip 102 defined between a mold roll 104 and a counter-rotating second mold roll 106′. An outer surface 200 of second mold roll 106′ includes structural features 232 configured to shape shallow channels 234 in resin base layer 26. In this embodiment, structural features 232 that form channels 234 are configured to form heads 116 extending from resin base 14 into the channels. Heads 116 are symmetrical stems whose cylindrical outer surface has a circumference that increases toward their distal ends. This tapering effect allows flowable conductive material 16 filling channels 234 to surround heads 116 while providing a mechanical resistance to the removal of the conductive material from base 12 after the conductive material is stabilized to form the antennae. In other embodiments, heads 116 are configured as hooks or as longitudinally-extending ridges. In still other embodiments, no heads are present in channels 234.

Structural features 232 are also configured to form channels 234 whose opening is narrower than the width of the base of the channel. Some other embodiments form channels 234 with different shapes. However, channels 234 with at least a portion whose width decreases with increasing distance from an opposite side of base 12 provide additional mechanical resistance to the removal of conductive material 16 from the resin base after stabilization.

Channels 234 are patterned, in shape, width and thickness, to correspond with a desired conductive material layout to form antennae in the finished product. In this embodiment, second mold roll 106′ is formed of a roller sleeve whose surface is etched to form structural features 232. Alternatively, second mold roll 106′ can be assembled from multiple rings, each ring including structural features 232 configured to shape shallow channels 234. The use of roll molding produces channels 234 in longitudinally extending repeating patterns. Multiple columns of antennae formed from respective longitudinally-extending patterns of channels 234 can be produced side-by-side on a single roll molding apparatus. As molten resin 140 enters nip 102, pressure in the nip forces the resin into the fastener element mold cavities and around structural features 232.

The system illustrated in FIG. 8 also includes a filling station 242 and a sealing station 244. Filling station 242 includes an inkjet 246 that dispenses ultraviolet curable conductive ink into channels 234. Ultraviolet emitter 248 radiates ultraviolet light that cures and solidifies the conductive ink in channels 234 to form conductive traces 16. Optionally, a second inkjet 250 dispenses a surface treatment (e.g., a solvent pre-wash, or an adhesive) into channels 234 to prepare the channels to receive the conductive ink.

The capacitance of the resonant circuit may be provided by a pad of conductive ink dispensed into a molded recess on one side of the base layer with the conductive trace forming the inductor, and a second pad of conductive ink or metallic coating formed on an opposite side of the base layer in a region aligned with the first pad, on the fastening side of the product. The thickness of base layer 26 provides the separation between the capacitive ‘plates’. Such a second pad of conductive material may be formed directly on the fastener elements, such as by techniques taught in U.S. Pat. No. 6,977,055. Trimming or tuning the resonance of the circuit in such instances may be accomplished by removing portions of one or more fastener elements within the second pad. The second pad may be electrically coupled to an associated microchip carried on the ink side of the product through a via, or may be mounted on the fastening side of the base layer.

Alternatively, the second side of the capacitor can be provided by a metallic foil applied over the pad of conductive ink and secured to the base layer 26 by a non-conductive adhesive tape that electrically separates the conductive ink from the foil layer. Or the capacitor can be provided as a preformed electrical component mounted and electrically coupled to the inductor after forming of the conductive traces.

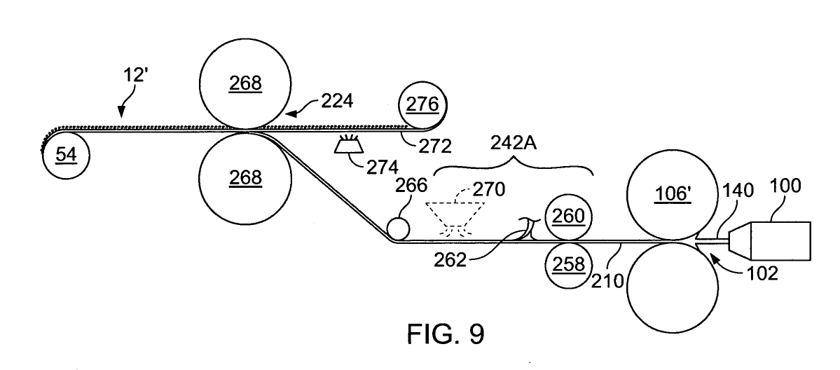

After conductive traces 16 are formed, sealing station 244 sprays a cover 28′ (e.g., an epoxy, an acrylate, or an epoxy-acrylate) on the upper surface of resin base layer 26. Cover 28′ is selected at least in part for its compatibility with and ability to bond to the resin of layer 26 and for its insulative properties. Cover 28′ and resin layer 26 cooperate to substantially insulate conductive traces 16 from each other and from the surrounding environment. Second sides of the capacitor may also be formed by a layer of conductive coating applied over the cover 28′. The resulting strip of RFID tag material is spooled for storage on storage roll 254. FIG. 8C illustrates the finished tag material releasably engaged with a loop material 299. The antennae may also be formed directly on a substrate that is then laminated to fastener material to form a continuous sheet of RFID fasteners. For example, in FIG. 9 a filling station 242A includes a print roll 260 and a doctor blade 262. As a strip 210 of resin molded to have channels 234 but no fastener element projections passes between print roll 60 and a second support roll 258, the print roll applies a quick-drying conductive material to the upper surface of resin strip 210. Conductive ink fills channels 234 and accumulates on the face of resin strip 210. Doctor blade 262 wipes accumulated ink from the face of strip 210 while leaving ink in channels 234 where the ink dries and solidifies to form conductive traces on the resin base as the resin base proceeds past tensioning roll 266 to lamination rolls 268. Optionally, filling station 242A also includes a hot air blower 270 which hastens the stabilization process by heating and ventilating the conductive ink to encourage the evaporation of the solvents which keep the ink in liquid form.

Filled resin strip 210 and preformed fastener tape 272 are fed into lamination nip 224 defined between lamination rolls 268. Heater 274 heats fastener tape 272 as the fastener tape proceeds from feed roll 276 into lamination nip 224. Fastener tape 272 is selected from fastener tapes which are compatible with the resin of strip 210. Thus, when heated fastener tape 272 proceeds through lamination nip 224 with strip 210, the fastener tape and the strip 210 cooperate in sealing and insulating conductive traces 16 within the base. In other embodiments, an adhesive is applied to fastener tape 272 before it enters lamination nip 224 rather than heating the fastener tape before it enters the lamination nip.

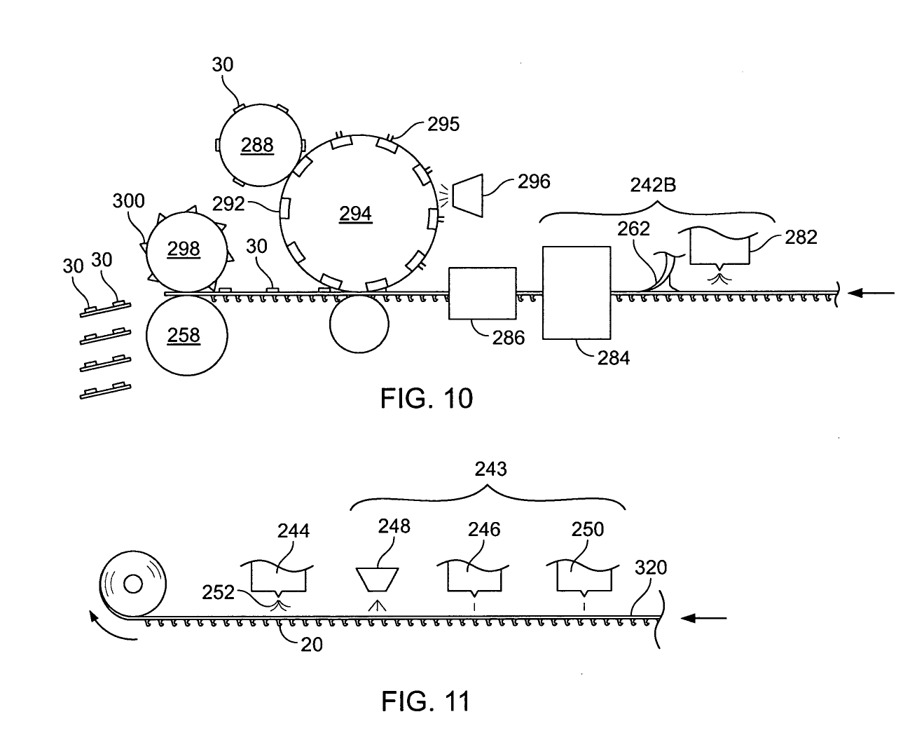

Referring to FIG. 10, another manufacturing method forms discrete RFID tags using a similar approach to that described above. A continuous strip of fastener tape with molded channels in its obverse side, formed as in FIG. 8, is fed into a filling station 242B that fills channels 234 with particles of metallic powder and forms conductive traces 16 by bonding these particles together. In filling station 242B, spray dispenser 282 sprays or otherwise dispenses particles of metallic powder on the upper surface of resin base layer 26. The particles of metallic powder fill channels 234 and accumulate on the face of resin base layer 26. Doctor blade 262 wipes accumulated particles from the face of resin base layer 26 while leaving particles in channels 234. The particles can have various geometries (e.g., angular or spherical) and fill channels 234 with adjacent particles touching at contact points while otherwise leaving interstitial voids between the particles. As resin base layer 26 passes through a sintering device 284, the sintering device emanates radio-frequency (RF) energy that causes eddy currents to develop within the particles in the channels. These currents cause the contact points between adjacent particles to heat up such that surface melting fuses the adjacent particles together at the contact points and locally melts resin of the channel walls touching the particles, but does not generally increase the density of the powder matrix. The result is an electrically conductive matrix extending along the channel as a trace. The metallic powder is preferably selected from a material (e.g., a tin-bismuth alloy) that has a high electrical conductivity and a low melting point and/or specific heat. Resin layer 26 with the stabilized metal forming conductive traces 16 passes through a chiller 286 to cool the metal and limit melting of the thermoplastic resin base.

In another embodiment, dispenser 282 sprays a liquid silver composition (e.g., a binding agent such as ethylenediaminetetraacetic acid (EDTA) or citric acid containing silver ions) on the resin base, instead of a metallic powder. The liquid silver composition contains reducing agents (e.g., ascorbic acid or ferrous ammonium sulfate) encapsulated in micro-bubbles. After doctor blade 262 wipes accumulated silver composition from non-channel regions of resin base layer 26, energy radiated by an ultrasonic emitter (not shown) releases the reducing agents initially contained by the micro-bubbles and solidifies the silver composition. In other embodiments, other liquid compositions of similar properties, including for example compositions with other metals such as copper or aluminum, are used to fill channels 234 and to form conductive traces 16 on resin base layer 26.

In some embodiments, the system also includes an electroplating station that electroplates a second conductive material onto conductive traces 16. This can increase the uniformity of the conductivity along the surface of conductive traces 16.

A component feed roll 288 places discrete electronic components 30 into receptacles 292 on a placement roll 294, with component pins or solder pads 295 directed radially outwards. Optionally, a solder pad heater 296 is placed to heat pads 295 of components 30 as placement roll 294 rotates to bring the components into contact with resin layer 26. Pins 295 of pin-bearing components contact and pierce conductive traces 16 and resin base layer 26, while solder pads 295 of surface mount components electrically join to traces 16. This provides both electrical connection and mechanical fastening for components 30. Each component 30 or set of components, electrically connected to an associated antenna trace, forms a trace-circuit pairing.

It can be difficult to spool tape with electrical components attached. Therefore, the illustrated manufacturing system includes a cutting roll 298. As the continuous tag material is pulled between cutting roll 298 and support roll 258, ridges 300 arranged on the peripheral surface of the cutting roll cut the longitudinally extending tag material into discrete RFID tags.

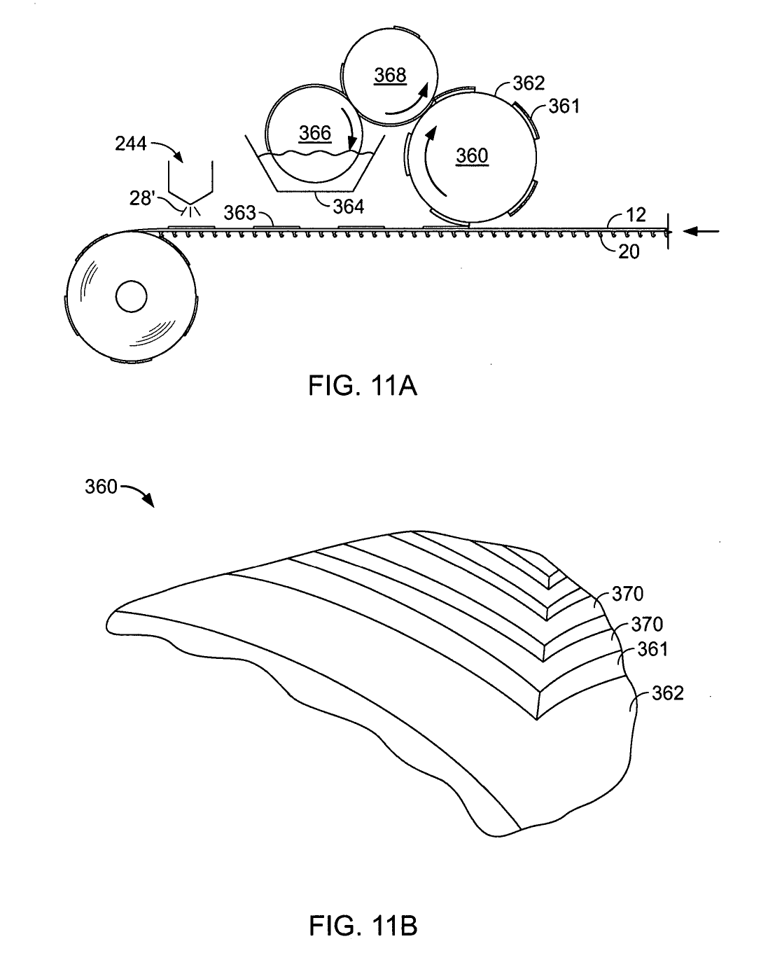

Referring to FIG. 11, in another manufacturing method a continuous molded resin hook tape 320, with an array of fastener elements 20 on its fastening side but without any trace channels on its obverse side, is fed into a printing station 243 that, like filling station 242 described above, includes an inkjet printer 246, an ultraviolet emitter 248, and, optionally, a second inkjet printer 250. Because the fastener tape base is channel-less, inkjet 246 dispenses ultraviolet curable conductive ink directly onto the upper surface of the resin base of hook tape 320 in the pattern of the desired conductive traces. Ultraviolet emitter 248 radiates ultraviolet light that cures and solidifies the conductive ink to form conductive traces (not shown) on the obverse surface of the molded hook tape. Optionally, a second inkjet 250 dispenses a surface treatment to predispose portions of the surface of hook tape 320 to receive the conductive ink. Sealing station 244 covers the conductive traces as described above.

Conductive ink may alternatively be applied by other means. For example, FIG. 11A shows a preformed hook tape to which conductive ink is applied by a printing roll 360 in a pattern determined by a series of raised areas 361 on the circumferential surface 362 of the roll. The ink 363 is transferred from an ink reservoir 364 to printing roll 360 by a series of transfer rolls 366 and 368. As shown in FIG. 11B, such raised areas 361 extend beyond the surrounding surface of the printing roll and have distal surfaces 370 that sequentially engage both transfer roll 368 and the non-fastening side of the fastener tape (FIG. 11A) to transfer a pattern of conductive ink. As an alternative, the non-fastening side of the fastener tape may be molded to have raised areas patterned according to a desired pattern of conductive traces, and the printing roller have a smooth circumferential surface that engages only the raised areas of the fastener tape material to transfer the conductive ink.

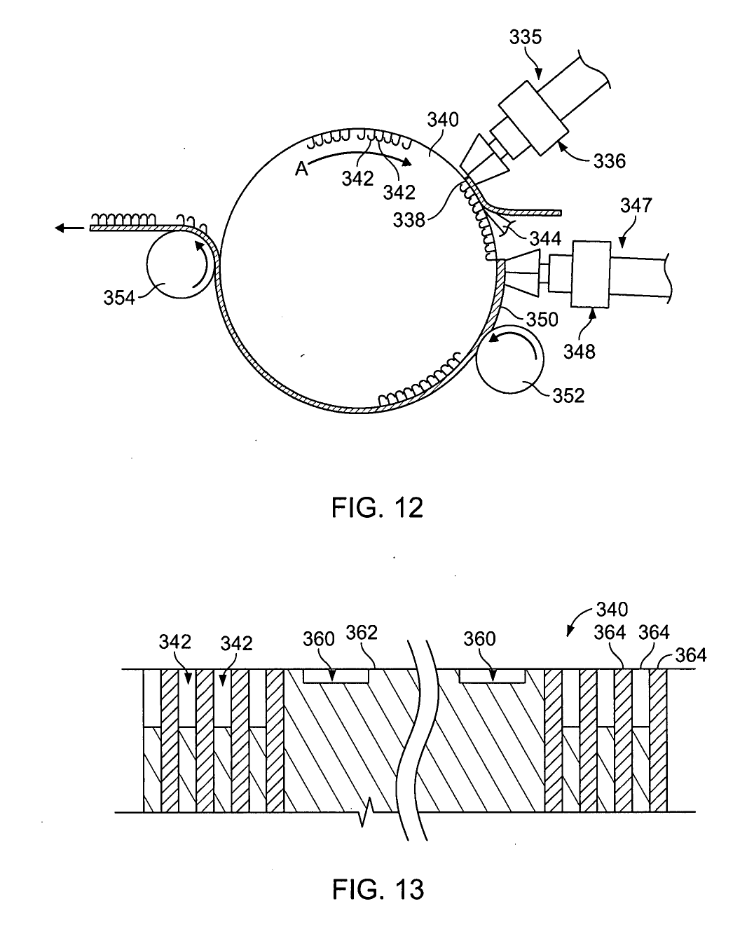

Another method, particularly useful for forming the fastener RFID tag of FIG. 5, is shown in FIGS. 12 and 13. A first extruder 335 extrudes a flowable composition 338 containing either metallic or carbon particles onto mold roll 340, forcing some of the composition into channels 360 defined in the surface of the roll and arranged to form the conductive paths of the RFID antennae, and leaving a layer of the conductive composition on the surface of the mold roll. As mold roll 340 rotates in the direction of arrow A, doctoring blade 344 removes essentially all of the conductive composition on the surface of the mold roll without disturbing the composition in the channels. The removed composition may be either discarded or returned to a hopper for reprocessing. The sharp, distal end of blade 344 rides against the mold roll, thereby literally scraping off essentially all of the composition on the surface of the roll. It is recommended that the end of the blade be coated with a lubricious material to avoid damaging the surface of the mold roll. Next, a second extruder 347 extrudes a fastener element-forming polymer 350 onto the surface of the mold roll across the region of the mold roll containing the conductive composition, filling arrays of projection cavities 342 on either side of the channels, to form fastener elements or fastener element preforms, and forming a resin base extending across and in intimate contact with the conductive composition still in the channels. As shown in FIG. 13, mold roll 340 has a central ring 362 defining channels 360, and two sets of projection molding and spacer rings 364, disposed on either side of central ring 362 and defining fastener element cavities 342. Central ring 362 may be of a width of about 25 millimeters, for example, while each molding and spacer ring 364 may be of a thickness of only about 0.1 to 0.2 millimeters.

A gear pump 336, 348, is positioned at the outlet of each extruder, to accurately control the rate of polymer delivered to the mold roll. The final thickness of the base of the product is then adjusted by roll 352, and the finished fastener RFID tape is stripped from the mold roll 340 by passing it around exit roll 354. The finished tape may then be severed to form the product of FIG. 5, in which the conductive material forming the antenna is elevated from the surrounding resin surface of the tag. The trace may be covered for protection and isolation, and auxiliary electronic components may be attached, as discussed above.

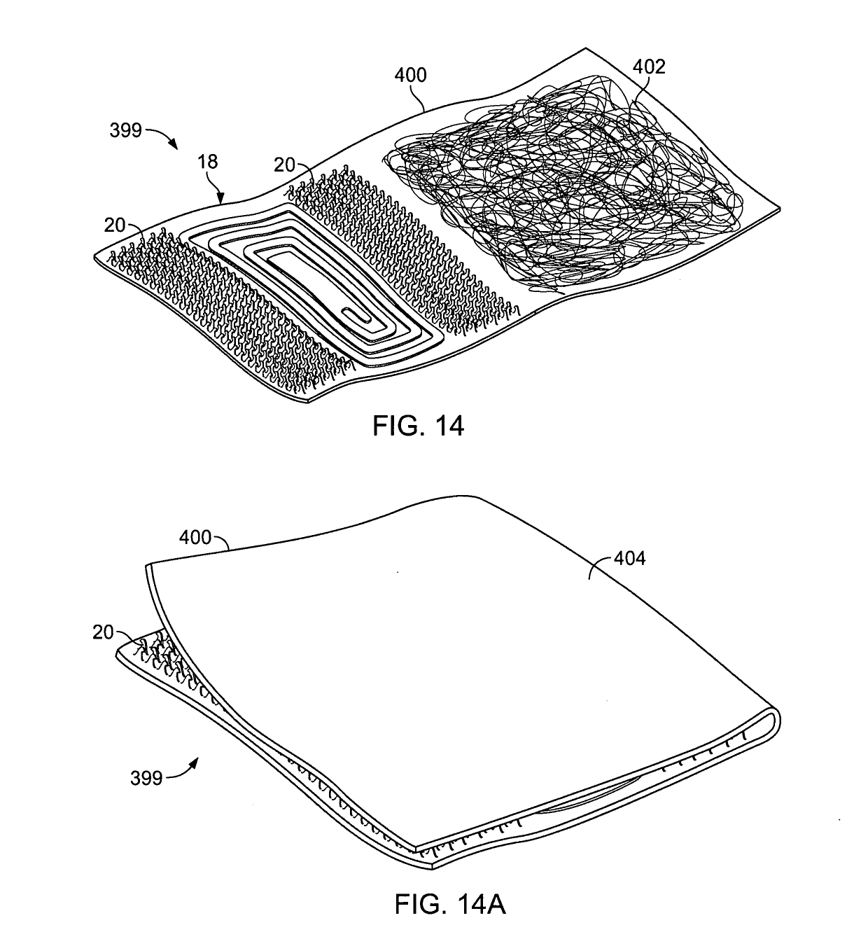

Referring next to FIGS. 14 and 14A, an RFID tag 399 includes a flexible resin substrate 400 that carries two arrays of male fastener elements 20, an RFID antenna 18 and related circuitry, and non-woven loop material 402 that forms a field of female fastener elements releasably engageable by male elements 20. The substrate 400 contains a conductive layer 404 that extends over substantially the entire extent of the substrate and under the RFID antenna and circuitry, such that when the substrate 400 is folded along a line between the male and female fastener elements (FIG. 14A), conductive layer 404 substantially encompasses the RFID antenna and renders the tag unreadable. In this manner the readability of tag 399 may be manually altered by simply fastening and unfastening the touch fastener elements. In use, tag 399 may be permanently mounted to an underlying surface across only the male fastener half of the tag, leaving the female fastener half either as an unsecured flap, or secured in a folded condition across the RFID antenna as shown in FIG. 14A if it is desired that the tag be initially unreadable. Tag 399 may be provided as separate panels rather than a foldable substrate.

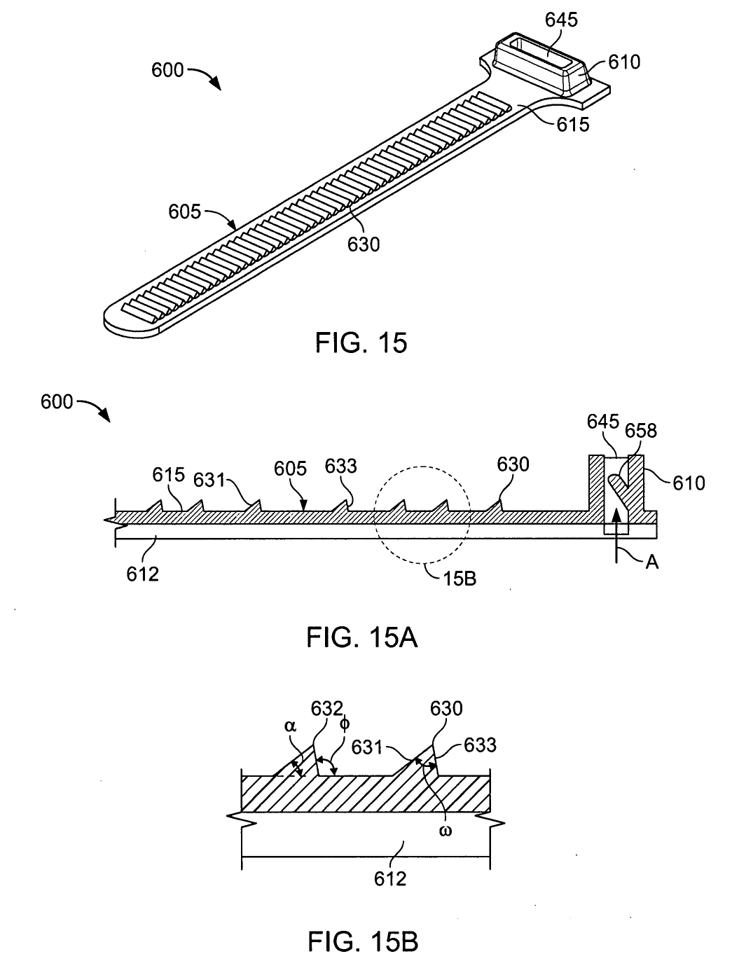

Referring to FIGS. 15, 15A, and 15B, a identification product 600 includes a fastener strap 605 and a head element 610. The fastener strap 605 includes a base 615 from which multiple fastener projections 630 extend. A microchip 607 is encapsulated between the base 615 and a backing layer 612. A conductive trace 609, also encapsulated between the base 615 and the backing layer 612, electrically connects microchip 607 with an RFID antenna (not shown) disposed at an opposite end of the fastener strap 605

The fastener strap 605 can have various different dimensions depending on its intended use. For example, the base 625 of the fastener strap 605 can have a thickness of between about 0.005 inch and 0.030 inch. The strap 605 can have a length of between about 3 inches and 36 inches. The width of the strap can range from about 0.25 inch and 1 inch. In some cases, it is beneficial to provide a relatively wide strap in order to broadly distribute the retaining load across the fastener product. Because the relatively wide strap broadly distributes the load, the fastener product is able to withstand more stress (e.g., sheer stress) than a similar product having a thinner strap. Similarly, the strength of the strap increases as the thickness of the strap increases.

The fastener projections 630 are in the shape of wedges. More particularly, a first surface 631 of the fastener projections 630 is substantially flat and inclined at an angle α of between about 10 degrees and 45 degrees relative to the planar base 615. A second surface 633 extends from the base 615 at a steeper angle of incline φ of between about 45 degrees and 90 degrees relative to the base 615. The second surface 633 joins the first surface 631 to form an apex 632. The apex can have an angle ω ranging from about 30 to 80 degrees. The projections 630 extend to a height of between about 0.01 inch and 0.05 inch above the base 615. The fastener projections 630 are arranged such that the second surfaces 633 all face in the same direction. In this case, the second sides 633 face toward the head element 610.

The dimensions discussed above are merely used to describe particular embodiments. Straps and projections of other suitable shapes and sizes capable of providing the product with fastening ability can be used.

The head element 610 defines an aperture 645. When the fastener strap 605 is inserted through the aperture 645, the head element 610 cooperates with the fastener projections 630 to prevent the strap 605 from retreating back through the aperture 645. In other words, the head element 610 is configured such that it provides one-way movement of the strap 605 through the aperture 645.

The head element 610 includes a retaining arm 658 that extends into the aperture 645. When the strap 605 is pulled through the aperture 645 in the direction of arrow A, the first surfaces 631 of the wedge-shaped fastener projections 630 deflect the retaining arm 658 away from the projections 630 allowing the strap 605 to proceed through the head element 610. However, when the strap 605 is pulled in a direction opposite to that shown by the arrow, the second surface 633 of the projection 630 abuts and engages the retaining arm 658. This prevents the strap 605 from exiting the head element 610.

This configuration provides straps configured for one time use. For example, a hospital or amusement park can provide wrist straps assigned to a particular patient (e.g., for confirmation of identity before administering medication) or guest (e.g., for confirming what level of access to park attractions has been purchased). As described above, the strap 605 is inserted through aperture 645 to secure the fastener product 600 around a user's wrist. A nurse or attendant can verify that the strap is snugly attached such that the wrist strap cannot be slipped off over the user's hand. In some cases, removal of the wrist strap requires cutting or breaking the strap 605, thus severing the electrical connection between the RFID antenna and the microchip 607, or altering the electrical characteristics of the antenna. When the electrical connection is broken, the wrist strap is inoperative.

In other embodiments, the retaining arm 658 can be configured to allow a user of the product 610 to release the arm 658 from engagement with the projection 630 to allow the strap 605 to be removed from the head element 610 after insertion. This enables the user to reuse the fastener product 610 multiple times. Other releasable fastening configurations, such as mating hook and loop fastener arrays, are also envisioned.

In particular embodiments, the head element 610 extends to a height of between about 0.1 inch (0.254 cm) and 0.4 inch (1.016 cm) above the base 615. Depending on the width of the strap 605, the width of the head can range from about 0.3 inch (0.762 cm) to 1.25 inch (3.175 cm). Head elements of other shapes and sizes capable of receiving the strap in the aperture to allow the strap to enclose the product in a fastened position can be used.

As discussed above, the fastener product 600 includes the backing material 612 attached to a bottom surface of the strap 605 opposite the surface from which the fastener projections 630 extend. The backing material can be one of various suitable materials including, for example, non-woven materials, knit materials, foam materials, and metallized film. Depending on the material from which the backing material 612 is composed, it can provide various benefits, as discussed above.

Fastener projections having other shapes can also be employed.

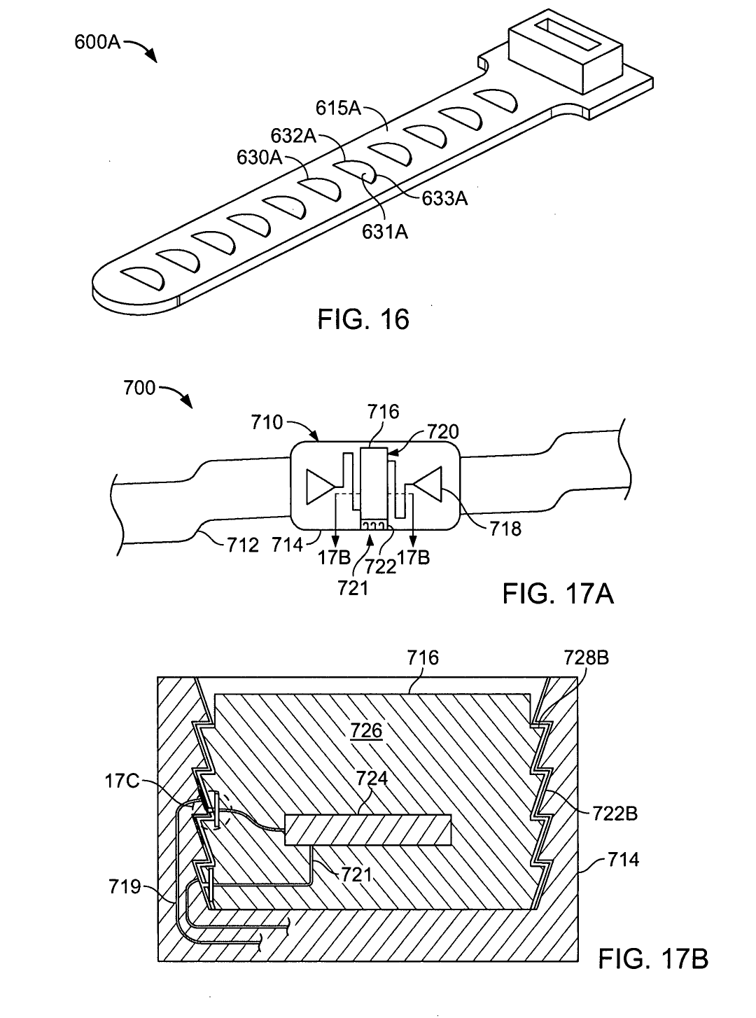

Referring to FIG. 16, for example, a fastener product 600A includes an array of arcuate engageable elements 630A integrally molded with and extending outwardly from a base 615A. The engageable elements each include an engageable side 633A and a non-engageable side 631A. The engageable side is inclined relative to the base at between about 5 degrees and 45 degrees. The non-engageable side 631A is inclined relative to the base at a steeper angle. The sides 633A, 631A join to form an apex 632A. The engageable side 633A is defined by an upper edge and a lower edge where the engageable element intersects the base 615A. Both the upper and lower edges define curves (e.g., circular curves) such that the engageable side 633A has a curved shape.

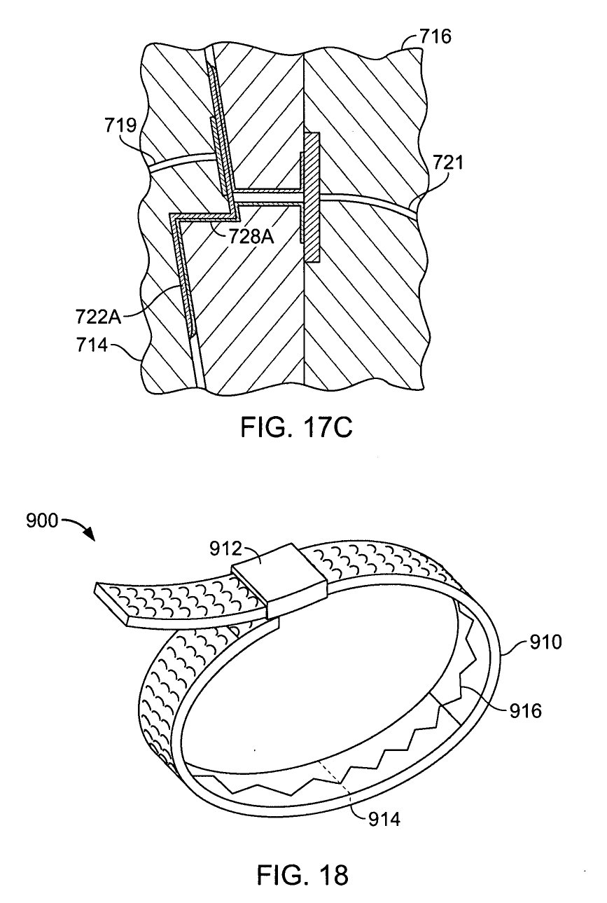

Referring to FIGS. 17A, 17B, and 17C, an identification product 700 includes an RFID module 710 mounted on a strap 712. The RFID module 710 includes an antenna assembly 714 which receives an insertable microchip assembly 716. Antenna assembly 714 has RFID antennae 718 disposed in an electrically insulative substrate. Aperture 720 includes a side opening 721. Fastening elements 722A, 722B extend from a surface of aperture 720. The fastening elements 722A, 722B are wedge shaped fastening elements as are described in more detail in U.S. Patent App. Pub. No. 2005/0183248 included herein by reference in its entirety. Some fastening elements 722A are electrically conductive and other fastening elements 722B are electrically insulative. Electrically conductive fastening elements 722A can include (e.g., be made of an electrically conductive material) or can be plated. Leads 719 (e.g., wires or traces of conductive material) electrically connect the RFID antennae 718 with electrically conductive fastening elements 722A.

Microchip assembly 716 includes a microchip 724 disposed in a block 726 of an electrically insulative substrate. The block 726 is sized to fit into the aperture 720 with the outer walls of the block 726 adjacent the inner surfaces of the aperture 720. Fastener elements 728A. 728B extend from side surfaces of the block 726 and are configured to engage fastener elements 722A, 722B. The fastening elements 722A, 722B are also wedge shaped fastening elements. Some of fastening elements 728A are electrically conductive and other fastening elements 728B are electrically insulative. Electrically conductive fastening elements 728A can include (e.g., be made of an electrically conductive material) or can be plated. Leads 721 (e.g., wires or traces of conductive material) electrically connect the microchip 724 with electrically conductive fastening elements 728A.

Referring to FIG. 17B, as the electrical component carrier is inserted down into the receptacle, the interfering retention features snap or click over one another until the carrier reaches the bottom of the receptacle, in which position electrically conductive pads on the carrier are aligned with respective ones in the receptacle to establish communication with the antenna.

Referring to FIG. 17C, electrical connection is made at the retention feature interface by electrically conductive plating on the engaged surfaces. The plating, applied only in discrete regions, extends over corners of the wedges, to ensure electrical connectivity on at least one side of the wedge. The plating on the inserted electrical component carrier extends through a hole in the fastener tape adhered to the side of the molded component carrier, to make connection with a conductive boss insert-molded into the carrier, as the fastener tape is adhered to the carrier. Alternatively, the entire fastener tape can be made of a conductive material, with tape applied to one side of the carrier making one electrical connection along one face bounding the receptacle, and another piece of fastener tape making a second, isolated electrical connection at the opposite face. Notably, simple insertion of the carrier into the receptacle establishes both mechanical retention and electrical connection.

In use, the identification product 700 is inoperative when microchip assembly 716 is not installed in RFID module 710. When it is desired to activate the identification product 700, a user presses the microchip assembly 716 into the aperture 720 until the fastener elements 728 engage the fastener elements 722. Other embodiments are implemented using other types of fastener elements (e.g., molded hooks on the microchip assembly 716 and loop material on the antenna assembly 714). Contact between electrically conductive fasteners elements 722A and electrically conductive fastener elements 728A provides an electrical connection between the antenna assembly 714 and the microchip assembly 716. If desired, the user can render the identification device 700 inoperative by sliding the microchip assembly out the antenna assembly 714 through the side opening 721 of aperture 720. Some embodiments are implemented with an aperture 720 that does not include a side opening.

In any of the above-described RFID fastener products, the male fastener elements themselves may have a conductive surface, for providing electrical power and/or communication through a hook-loop or hook-hook interface, such as is taught in U.S. Pat. No. 6,977,055, issued Dec. 20, 2005 and incorporated by reference herein in its entirety.

Other useful features can be found in PCT Application Serial No. PCT/US01/46045, filed Oct. 25, 2001, U.S. Provisional Application Ser. No. 60/293,743, filed May 25, 2001, U.S. Provisional Application Ser. No. 60/323,244, filed Sep. 19, 2001, U.S. Provisional Application Ser. No. 60/243,353, filed Oct. 25, 2000, and U.S. application Ser. No. 10/423,816, filed Apr. 25, 2003, the entire contents of all of these earlier filings being hereby fully incorporated by reference.

A number of embodiments of the invention have been described. Nevertheless, it will be understood that various modifications may be made without departing from the spirit and scope of the invention.

In another example, referring to FIG. 18, identification product 900 is substantially similar to identification product 600 (see FIGS. 15, 15A and 15B) in general structure. However, fastener strap 910 is attached (e.g., adhesively attached) to head element 912 rather than being integrally formed with the head element 912. In addition, rather than a conductive trace 609 (see FIGS. 15A and 15B) connecting a microchip and an RFID antenna, the identification product 900 includes an RFID antenna 916 that extends through the length of the fastener strap 910. The fastener strap 910 includes weakened region 914 configured to preferentially fail in response to force applied to remove the identification product 900. The weakened region 914 is disposed extending across the RFID antenna 916. Thus, if a user pulls on the fastener strap 910 to remove the identification product 900, the strap will break in weakened region 914 and the antenna will separate into two pieces, rendering the identification product 900 inoperable.

Accordingly, other embodiments are within the scope of the following claims.

What is claimed is:

1. An identification tag comprising
a flexible sheet-form base having a broad surface formed of resin;
electrically conductive material carried by the base, forming a conductive path and defining at least a portion of an antenna responsive to externally applied electromagnetic radiation oscillating at a predetermined frequency; and
an array of fastener elements extending from the broad surface of the base, the fastener elements arranged and constructed to engage mating fastener elements to selectively secure the tag.

2. The identification tag of claim 1 wherein the fastener elements are shaped to releasably engage exposed loop fibers associated with a supporting surface to which the tag is to be secured.

3. The identification tag of claim 2 wherein the fastener elements comprise raised projections of the resin of the broad surface of the base.

4. The identification tag of claim 3 having an entire thickness, measured from distal ends of the fastener elements to an exposed broad surface of the base opposite the fastener elements, of less than about 0.1 inch (2.5 millimeters).

5. The identification tag of claim 4, wherein the entire thickness is less than about 0.05 inch (1.25 millimeters).

6. The identification tag of claim 1 wherein the fastener elements each have stems molded of resin contiguous with the resin forming the broad surface of the base.

7. The identification tag of claim 1 wherein the antenna is encased within the base.

8. The identification tag of claim 7 wherein the antenna is disposed between a first layer of resin forming the broad surface and insulating one side of the antenna, and a second layer of resin insulating another side of the antenna.

9. The identification tag of claim 8 wherein the first and second layers of resin consist of a single, seamless extent of a single resin material.

10. The identification tag of claim 8 wherein the first and second layers are of differing material properties.

11. The identification tag of claim 1 wherein the fastener elements each have a height, measured from the broad surface of the base, of less than about 0.05 inch.

12. The identification tag of claim 1 further comprising at least one discrete electrical component carried by the base and coupled to the antenna.

13. The identification tag of claim 12 wherein the electrical component comprises a circuit mounted in a sealed housing at least partially embedded in the base.

14. The identification tag of claim 13 wherein the sealed housing is fully disposed within the base resin.

15. The identification tag of claim 12 wherein the electrical component comprises a circuit in electrical communication with the antenna and at least partially electrically isolated by resin of the base.

16. The identification tag of claim 1 in elongated strap form, wherein the fastener elements are configured to secure the tag in place when the tag is wrapped about an object to engage itself.

17. The identification tag of claim 16 comprising a wrist strap.

18. The identification tag of claim 16 wherein the tag has a head defining an aperture adjacent one end of the tag, and wherein the fastener elements comprise a row of projections that cooperate with a feature of the head to prevent withdrawal of the tag from the aperture with an opposite end of the tag inserted through the aperture.

19. The identification tag of claim 16 wherein the fastener elements are configured to releasably engage other fastener elements of the tag when the tag is wrapped about an object to engage itself.

20. The identification tag of claim 16 wherein the base defines a discrete frangible region spaced from longitudinal ends of the tag and spanning at least one electrically conductive member of the tag, such that breaking the base at the frangible region renders the tag inoperable.

21. The identification tag of claim 1 defining a receptacle sized to receive an electronic component, the tag comprising electrically conductive connection surfaces positioned to establish electrical connectivity between the antenna and the received component.

22. The identification tag of claim 21 in combination with an electronic component disposed within the receptacle, the electronic component comprising a microprocessor and containing a unique component identification code.

23. The identification tag of claim 21 wherein the receptacle is bounded by at least one wall having component retention features that extend into the receptacle and prevent removal of a received electronic component.

24. The identification tag of claim 21 wherein the receptacle includes an electronic component removal slot arranged to permit sliding a received electronic component laterally out of the receptacle.

25. A method of continuously forming a series of identification tags, the method comprising:
introducing a thermoplastic resin into a gap formed adjacent a peripheral surface of a rotating mold roll, the mold roll defining an array of cavities therein, the resin being introduced under pressure and temperature conditions selected to cause the resin to at least partially fill the cavities to form fastener element stems integrally with and extending from one broad surface of a strip of said resin; while
introducing a preformed strip into the gap, the preformed strip comprising a support substrate carrying a series of discrete electrical traces configured to form at least portions of antennae responsive to externally applied electromagnetic radiation oscillating at a predetermined frequency, the preformed strip introduced so as to cause the resin to bond with the preformed strip and form a laminate material having a flexible resin base carrying both an exposed array of fastener element stems and a series of antennae.

26. The method of claim 25 further comprising severing the laminate material into discrete identification tags, each tag containing an antenna and a multiplicity of exposed fastener elements.

27. The method of claim 25 wherein the electrical traces each comprise a continuous, coiled, flexible trace of conductive material forming a conductive path of length greater than a lateral extent of the antenna.

28. The method of claim 25 wherein the cavities of the mold roll are shaped to mold distal heads on the fastener element stems, the distal heads being shaped to overhang the broad surface of the strip of resin so as to be releasably engageable with exposed loop fibers.

29. The method of claim 25 wherein the gap comprises a nip defined between the rotating mold roll and a counter-rotating pressure roll.

30. The method of claim 25 wherein the support substrate comprises a film carrying the conductive material on a surface thereof, the resin being introduced to the gap directly adjacent the rotating mold roll, the film being introduced to the gap under pressure and temperature conditions which cause the film to become permanently bonded to the resin to envelop and electrically isolate the antennas.

31. A method of forming a series of identification tags, the method comprising:
molding a continuous, flexible base of an electrically insulating thermoplastic resin, while forming a series of channels in a surface of the base;
at least partially filling the formed channels with a flowable, electrically conductive composition;
stabilizing the flowable composition in the channels to form a pattern of stable, electrically conductive traces within the channels; and
providing a series of discrete electronic circuits carried by the flexible base, each circuit electrically connected to a corresponding one of the traces to form a trace-circuit pairing;
wherein each trace-circuit pairing is responsive to externally applied electromagnetic radiation oscillating at a predetermined frequency.

32. The method of claim 31, wherein the composition is stabilized in the channels by evaporating a solvent from the composition, or by radiating the composition in the channels with radiation selected from a group consisting of heat, ultraviolet radiation, and microwave radiation, or by subjecting the composition to reducing conditions, or by releasing reducing agents from capsules contained within the flowable composition.

33. The method of claim 31, wherein molding the base comprises feeding the thermoplastic resin in a moldable form into a gap adjacent a mold roll.

34. The method of claim 33, further comprising forming a field of loop-engageable fastener elements extending from the base by:
introducing the resin into the gap such that the resin fills a field of fixed cavities defined in the mold roll to form a field of molded stems;
solidifying the molded stems;
stripping the stems from the mold roll; and
forming loop-engageable heads on the molded stems.

35. The method of claim 31, further comprising providing a field of loop-engageable fastener elements on the base exposed to releasably secure the base to a loop-bearing support.

36. The method of claim 31, further comprising attaching an electrically insulating cover over the conductive traces, the cover attached to the base.

37. A method of forming a flexible identification tag with integral touch fastener elements, the method comprising:
introducing an elongated flexible circuit strip including a substrate and a series of longitudinally spaced apart tag circuits carried by the substrate to a gap adjacent a peripheral surface of a mold roll having an array of stem forming cavities extending inwardly from the peripheral surface, while simultaneously
introducing a thermoplastic resin into the gap directly adjacent the peripheral surface under temperature and pressure conditions causing the thermoplastic resin to at least partially fill the stem forming cavities and to permanently bond to the substrate; and then
stripping the permanently joined thermoplastic resin and substrate from the mold roll to expose the fastener element stems.

38. An electronically readable wrist strap comprising
an elongated and flexible strip of resin having opposite longitudinal ends and securable about a wrist of a wearer;
electrically conductive material carried by the strip and forming a conductive path that defines at least a portion of an antenna responsive to externally applied electromagnetic radiation oscillating at a predetermined frequency; and
electronic circuitry in electrical communication with the antenna and containing an electronically readable identification code;
wherein the strip defines a discrete frangible region spaced from the longitudinal ends and spanning at least one electrically conductive member of the strap, such that breaking the strip at the frangible region to remove the strap from the wrist renders the strap unreadable.

39. The electronically readable wrist strap of claim 38, further comprising an array of fastener elements extending from the broad surface of the base, the fastener elements arranged and constructed to engage mating fastener elements to selectively secure the tag.

40. The electronically readable wrist strap of claim 39, wherein the fastener elements comprise raised projections of the resin of the broad surface of the base.

41. The electronically readable wrist strap of claim 38, wherein the antenna is disposed between a first layer of resin forming the broad surface and insulating one side of the antenna, and a second layer of resin insulating another side of the antenna.
